(19) United States
(12) Patent Application Publication
(10) Pub. No.: US 2019/0034610 A1
(43) Pub. Date: Jan. 31, 2019

(54) MOBILE APPLICATION FOR AUTOMATIC INFORMATION SYNTHESIS

(71) Applicant: MORPHOTRUST USA, LLC, Billerica, MA (US)

(72) Inventor: Stephen Miu, Chelmsford, MA (US)

(73) Assignee: MORPHOTRUST USA, LLC, Billerica, MA (US)

(21) Appl. No.: 16/050,791

(22) Filed: Jul. 31, 2018

Related U.S. Application Data
(60) Provisional application No. 62/539,066, filed on Jul. 31, 2017.

(51) Int. Cl. G06F 21/32; G06F 21/34; G06K 9/00; G06K 9/62

(52) U.S. Cl. CPC G06F 21/32; G06F 21/34; G06F 2221/2117; G06K 9/00362; G06K 9/6202; G06K 9/00456

(57) ABSTRACT

Methods, systems, and apparatus, including computer programs encoded on a computer storage medium, for accessing information encoding an identification document of a subject. The identification document includes biometric information for the subject. A computing device determines that the identification document is authentic. In response to the device determining that the document is authentic, the device verifies the validity of personally identifiable information on the identification document. In response to a determination of validity, the device is used to obtain a live biometric of the subject. The obtained live biometric is compared with biometric information from the identification document that has been authenticated. In response to the comparison indicating a match, a system determines that the subject is the person identified by the identification document. The system extracts personally identifiable information from the identification document to register the subject.

### FIELD

The present specification is related generally to registration of users.

### BACKGROUND

Identification document presented by a person often needs in-person authentication. Certain regulations or business practices may require that a person present and verify their identity such as for purposes of employment eligibility. An electronic means to verify identity records and match them to an individual will create greater confidence in the verification of an individual's identity, establish a record of regulatory compliance and allow processing of records for individuals who may operate remote from those administrators responsible for verifying an individual's credentials. Information from such as identification documents may be used to register the person for in-person enrollment.

### SUMMARY

One aspect of the subject matter described in this specification can be embodied in a computer-implemented method. The method includes, accessing, at a mobile computing device, information encoding an identification document of a subject, the identification document comprising biometric information for the subject. A mobile enrollment application of the computing device is used to verify the validity of personally identifiable information (PII) including the biometric information on the identification document. In response to verifying the validity of the PII, the enrollment application obtains a biometric of the subject. For example, the enrollment application can use an optical scanning device (e.g., a digital camera) of the mobile computing device to obtain the biometric of the subject. The mobile computing device is used to determine that the subject is the person identified by the identification document based on the obtained biometric and the PII. The enrollment application uses the mobile computing device to extract at least a portion of the PII from the identification document to register the subject.

These and other implementations can each optionally include one or more of the following features. For example, in some implementations, verifying the PII includes: detecting a security feature of the identification document using the information encoding the identification document; authenticating the identification document in response to determining that the detected security feature corresponds to security information in an identification database associated with a jurisdiction that issued the identification document; and in response to authenticating the identification document, verifying that the PII on the identification document is valid.

In some implementations, determining that the subject is the person identified by the identification document includes: comparing the obtained biometric with biometric information from the identification document that has been authenticated; determining a match between the obtained biometric and at least a portion of the biometric information from the identification document; and in response to determining the match, determining, by the mobile computing device, that the subject is the person identified by the identification document.

In some implementations, the PII includes demographic information and the method further includes: extracting the demographic information from the identification document; accessing an enrollment template; and loading the extracted demographic information into the enrollment template to register the subject. In some implementations, the method further includes: receiving, at the mobile computing device, an indication comprising employment data about the subject; and loading the employment data into the enrollment template, wherein the employment data is loaded concurrent with the extracted demographic information to register the subject.

In some implementations, the method further includes: obtaining, at the mobile computing device, an eligibility document configured to receive data about the subject; and populating the eligibility document with one or more of: the extracted demographic information; the PII on the identification document that has been verified as valid; or the biometric information from the identification document that has been authenticated. In some implementations, the method further includes: using at least the PII on the identification document that has been verified as valid to confirm an eligibility status of the subject.

In some implementations, the eligibility document is an employment eligibility form and the method further includes: determining, using the mobile computing device, whether the subject is eligible for employment based on information from the authenticated identification document; and receiving, at the mobile computing device, a verification result that indicates whether the subject is eligible for employment.

Other implementations of this and other aspects include corresponding systems, apparatus, and computer programs, configured to perform the actions of the methods, encoded on computer storage devices. A computing system of one or more computers or hardware circuits can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The subject matter described in this specification can be implemented in particular embodiments to realize one or more of the following advantages. A mobile application of a computing device or system executes specific computing rules for authenticating an identification document, verifying information included on the document, and extracting identifiable information to determine or verify an eligibility status of the person. The extracted information can be used to register the person for a particular activity or to enroll the person at a particular institution. The eligibility status can be employment eligibility and the specific computing rules described in this document can be used to verify (e.g., remotely verify) whether the person is eligible for employment.

The computing processes described in this document enable a repeatable automated process for effectively combining document authentication with biometric data validation that previously could not be performed by computer systems in an efficient or secure manner. The system uses a specific set of computational rules that consistently and efficiently enable non-local or remote authentication of identification documents and verification of identifiable information included on a document. As such, the described techniques enable a computer to perform operations that the computer was previously unable to perform due to the computational and data security challenges of performing document authentication and validation of biometric data for a subject. This document authentication and validation of biometric data allows the subject the option of remotely presenting identity credentials to facilitate enrollment in a system.

Details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example of a schematic arrangement in which a mobile computing device is used to authenticate an identification document, verify the personally identifiable information on the identification document, validate an identity assertion of a person, and enroll the person in a system.

FIG. 1B-1C show examples of an identification document.

FIG. 2 shows an example of a process for combining document authentication with biometric validation so that a subject can remotely assert an identity and enroll in a system.

FIG. 3 shows an example of a process for employment eligibility verification for a job applicant.

Like reference numbers and designations in the various drawings indicate like elements.

### DETAILED DESCRIPTION

In general, this specification describes methods and systems of using a mobile computing device, such as a smartphone device, to authenticate that an identification document has not been tampered with or otherwise complies with the standards of an authentic form of identification. The described techniques can be used to confirm the personally identifiable information on the identity document matches current government issued identity records or other records of identity. The techniques can be used to validate the person presenting the identification document is the person portrayed on the identification document, and if validation is successful, enroll the person by automatically aggregating demographic information from the identification document so that such information is automatically entered and without user intervention.

In one illustration, employment enrollment can be fully automated and/or remotely executed. As a person starts his or her first day at work, the person needs to be registered by the company as an employee, for example, a full-time employee. This registration serves as the basis for the person to be on the payroll of the company to receive compensation. This method and system enables employers to comply with, in an autonomous manner, government requirements for the verification of employment authorization and identity verification of new employees such as the requirements of the Federal E-Verify program. At the same time, the registration provides the reporting information for tax-withholding including federal tax, state tax, local tax, social security tax, and Medicare/Medicaid tax. What is more, the registration collects information to enroll the person into the benefits network of the employer. Such benefits may include healthcare insurance plan, tax-deferred retirement plan, employee stock purchase plan, and profit-sharing plan.

Some implementations may use a mobile application on a smartphone device to authenticate a government issued identification document, such as a driver's license, as passport, or a birth certificate. If the identification document is determined to be authentic, the mobile application may obtain or receive biometrics from the person, and compare such lively taken biometrics with the biometric information on the identification document. If there is a match, a determination may be made that the person whose biometric is taken is the person identified by the identification document. If the identification document is authentic and the person is identified by the identification document, the mobile application may use the personally identifiable information from the identification document to populate the various tables and forms that may be required for payroll registration and benefits enrollment. The automatic population would present tables and forms in complete or almost-complete form for the user to review and sign. In this scenario, authentication, validation, and registration can be fully automatic without interventions from a human resource (HR) specialist. In some cases, the entire enrollment process can be conducted remotely, for example, from the employee's home and without a HR specialist being present at the employee's home.

Other implementations may automate enrollment and registration processes for academic institutions, bank/financial accounts, retail loyalty programs, registration for club membership, or related enrollment processes, such that the enrollment and registration would likewise enjoy the benefit and convenience afforded by the described systems and techniques. In the case of registering for school or academic institution, a mobile application may leverage the identity proof carried by, for example, a government-issued driver's license. In one illustrative example of school enrollment at an undergraduate or graduate institution, the admitted student may launch the mobile application to authenticate his/her driver's license, validate that he/she is the person identified by the driver's license, and have the personally identifiable information automatically populated to forms such that the admitted student does not have to enter such information repetitively. While these forms may still need the admitted student's signature, or supplemental information (such as fingerprint input or stylus signature), the enrollment process is largely complete by virtue of machine-assisted automatic authentication, validation, and information gathering. Indeed, the enrollment may be performed remotely to accommodate spikes in the demand for enrollment or to provide additional enrollment options to traditional brick-and-mortar office locations.

In a similar vein, the automated process is applicable to registration for a club membership, account opening at certain institutions, or any other process which includes an identity confirmation of the enrollee. In these cases, because an identity proof can be gleaned from the identification document, the mobile application can perform screening based on this official form of information after the mobile application has authenticated the identification document as genuine.

Implementations disclosed herein are not merely aimed at automating an otherwise manual process or registration. In one aspect, an HR specialist or secretary is untrained for detecting counterfeit identification documents. The mobile application, as described herein, performs authentication of the underlying identification document, thereby enhancing the ability to screen out counterfeit identification documents and improving the robustness of enrollment.

In another aspect, enrollment or registration, however tedious, is not known to be a scalable process. Indeed, these tasks tend to consume the bandwidth of an HR specialist or secretary such that the throughput of processing registration is rather limited, especially at peak time when batches of new employees or students are in need of enrollment/registration. What is more, the registration through an HR specialist or an administrative person is highly centralized. The implementations disclosed herein solves the problem by virtue of distributive processing, potentially through the mobile computing device of each person seeking registration. Indeed, large-scale on-line payment networks, on-line ride-sharing networks, on-line retailer networks, or on-line resource-referral networks may additionally benefit from a registration module based on a mobile application that leverages the government-issued identification document for each participant. In some implementations, a mobile application can federate the enrollment process by leveraging centralized rules, especially as dictated by the United States Citizenship and Immigration Service (USCIS) and Department of Human Services (DHS).

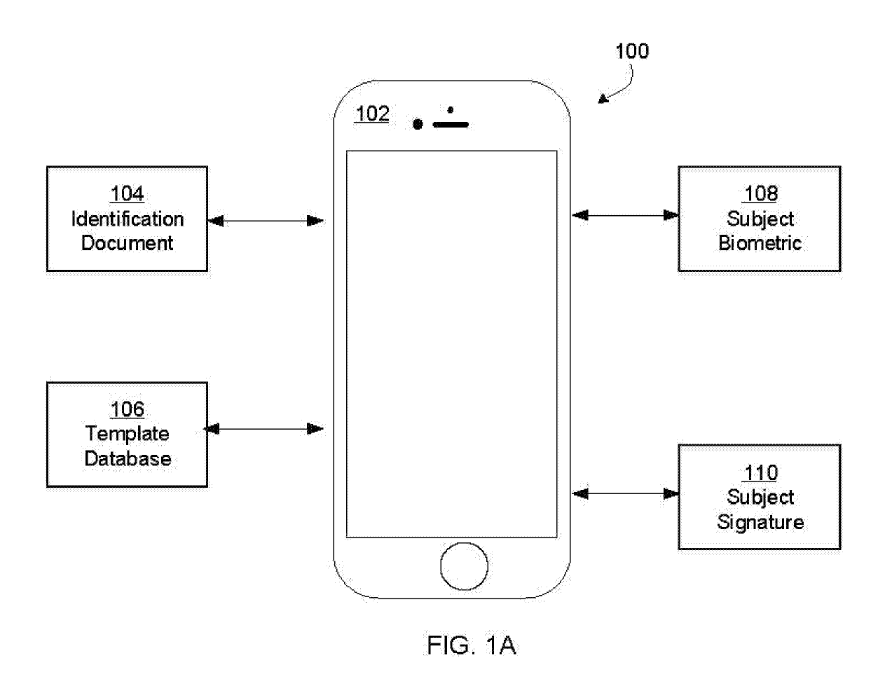

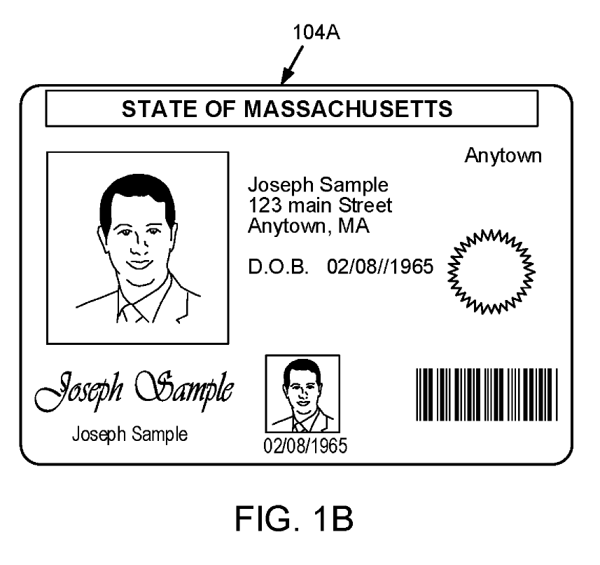

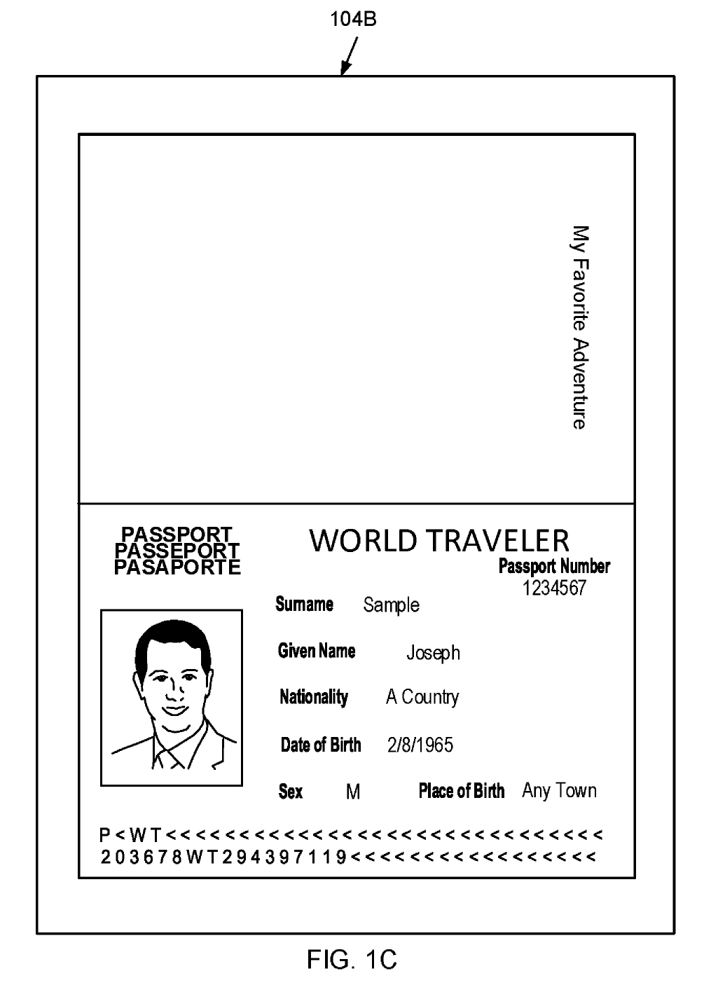

FIG. 1A is a schematic diagram illustrating an example of the workflow 100 of using a mobile application to perform subject enrollment by combining document authentication, subject verification, and information aggregation/synthesis. In this illustration, mobile computing device 102 is loaded with, for example, a mobile application. The mobile application utilizes sensor devices on the mobile computing device including a camera device, a microphone device, a fingerprint scanning device, or a retina scanning device. In some implementations, the mobile application uses related scanning and optical devices of a computing device. The scanning and optical devices are configured to obtain data representing biometric or other physical features of a person.

The mobile application authenticates an identification document 104 first. In some examples, the identification document includes a physical identification document, such as a driver's license, a passport, a birth certificate, a visa, a permanent resident card, a social security card, a Medicare/Medicaid card, or a military ID card. The term “identification document” may encompass any government-issued credentials that can be used to assert an identity claim, depending on the purpose and context.

In these examples, a camera device on the mobile computing device may be utilized to authenticate the physical copy. In particular, the camera device may generate a high-resolution image of the identification document. Based on the high-resolution image, various security features from the identification document may be detected, and correlated to determine that the physical copy of the document is a genuine copy as issued by an issuing agency. In some implementations, the physical identification document has multiple layers (e.g., substrate layers) and at least one layer may be referred to as a “blank.” This blank layer of the identification document is used to add various personalization features that can correspond to at least one security feature of the document.

To verify or validate that an identification document is authentic, one or more systems or devices described in this document can be configured to authenticate that a blank substrate layer of a physical ID document is a “genuine” layer. For example, a device can scan the identification document to identify or detect the substrate layer. In response to identifying the substrate layer, the device can identify and analyze features of the layer at the document to verify that certain security features and personalization fonts have been placed at the blank substrate layer of the identification document. In some implementations, the device ensures that the features and fonts have been added to the blank layer in accordance with a predefined placement “formula” that is specific to the particular identification card.

In other examples, the identification document includes a digital identification document of, for example, a driver's license, a passport, a birth certificate, a visa, a permanent resident card, a social security card, a Medicare/Medicaid card, or a military ID card. In these examples, the digital image of the digital identification document may be redirected to the mobile application for the authentication purpose. The examples of using a physical copy of a driver's license and the examples of using a digital driver's license are not mutually exclusive.

FIG. 1B shows an example 104A of a driver's license, which can be a physical copy or a digital version. An example 104B of a passport is shown in FIG. 1C, which can be either physical or digital.

When a driver's license is needed for the enrollment process, the subject may present the required driver's license for the automatic authentication. In other enrollment processes, for example, when the subject needs work authorization, more forms of identification document may be needed, including, for example, the passport, the employment authorization card, the permanent resident card, the work visa, etc. The mobile application is configured to discern or determine the need for such documents. Indeed, to prepare for an I-9 employment verification form, the US government mandates each employer to garner or obtain the authorization information from each employee. Such information must be current. The mobile application (“mobile app”) is thus configured to detect out-of-date document as well as fraudulent/counterfeit documentation.

In some implementations, a template database 106 of current documents from various jurisdictions are referenced, analyzed, or otherwise consulted to determine the authenticity of the underlying document. There may be more than one template per jurisdiction by virtue of concurrent standards endorsed by the jurisdiction. In some examples, the templates may be stored remotely. In these examples, the mobile app may access these templates via a cloud service. In this cloud service example, a comparison engine may be implemented in the cloud. The comparison engine is configured to compare at least two sets of information. The information can be associated with, for example, the identification document 104 and various other types of information for data stored at template database 104, biometrics obtained from a person, or data stored in an example identification database.

In the examples where the templates are stored remotely, the mobile application may be loaded to perform a comparison engine/module to compare the local document with the templates stored remotely. The disposition (including generating a confidence score) can take place either at the mobile app or remotely. For example, information from the local document may be transmitted to a database for comparison with the templates. In some cases, the template data may be resident locally, such as on the mobile computing device. When the security concern is relatively mild, for example, registering for non-profit work outside sensitive majors may rely on local templates, whereas enrolling for employment in defense-related industries may require consultation with a remote database of templates.

When the underlying identification document has been authenticated as a genuine copy, the mobile application may rely on this identification document to validate that the subject attempting to enroll is the person identified by the identification document. As the identification document carries information about the biometrics of the identified person, the mobile application may cause the mobile computing device to collect or obtain a biometric (108) from the subject attempting to register. In some implementations, the mobile application may configure the camera device of the mobile computing device to capture a facial biometric of the subject. To the extent that some implementations incorporate gait analysis, the mobile application may also configure the camera device of the mobile computing device to capture a video clip of the subject's strolling pattern.

In other implementations, the mobile application may prompt the subject to press his or her fingertip(s) on a scanner device so that a fingerprint of one of the fingers can be captured. In still other implementations, the mobile computing device may perform a retina scan by prompting the user to stare into an iris, retina, or eye-scanning device. In these implementations, the eye-scanning device may be onboard the mobile computing device. The eye-scanning device may also be located outside the mobile computing device while remaining in communication with the mobile computing device.

Some implementations may rely on the subject's signature. In these implementations, the mobile application may configure a touch screen of the mobile computing device to capture a signature freshly executed by the subject and then compare the lively captured signature with the information from the identification document that has been authenticated. Some implementations may incorporate voice recognition. For example, the mobile application may configure a microphone device of the mobile computing device to record a speech segment from the subject that is freshly uttered. Thereafter, speaker recognition may be performed based on the lively captured speech segment. For example, extracted parameters from the lively captured speech segment may be compared with known parameters of the subject. In other examples, the lively captured speech segment may be compared with a pre-recorded voice sample from the subject.

These implementations incorporate quality control mechanism to capture biometrics from the subject with sufficient details for comparison with biometric information from the identification document. What is more, the biometrics are captured in a manner that the liveness of such capture is enforced. For example, the facial curvature of a live person can be a basis to determine whether facial portraits taken from various angles on an arc. In some cases, illumination patterns may be modulated and reflections from certain portions of the facial portrait (such as the cornea region) can be analyzed to determine whether corresponding patterns are reflected. These live biometrics may be compared with the biometric information from the identification document.

If the subject is validated as the person identified by the identification document, the mobile application may parse information from the underlying identification document to generate forms for the subject to sign off. In the employment enrollment example, I-9 employment verification form may be generated based on the personally identifiable information gleaned from the underlying identification document. Similarly, benefit enrollment forms can be prepared using the same information. To the extent other information, such as emergency contact, may still require user input, the subject may enter such information. But otherwise, the enrollment process can be free from human intervention except for subject review and signature (110).

Importantly, the scalable and automated registration process may allow for additional determination of the subject's eligibility for registration. In one illustration, the mobile application, in completing and submitting the I-9 form, may receive indication of concurrent employment of the subject. The indication may be used to prepare tax-withholding form and/or benefit enrollment forms. In another illustration, the mobile application, when signing up a user for credit card application or on-line payment network (e.g., Apple Pay, or Google Wallet), may be able to rely on the underlying identification document to link the subject's bank account to the credit card account or the on-line payment account.

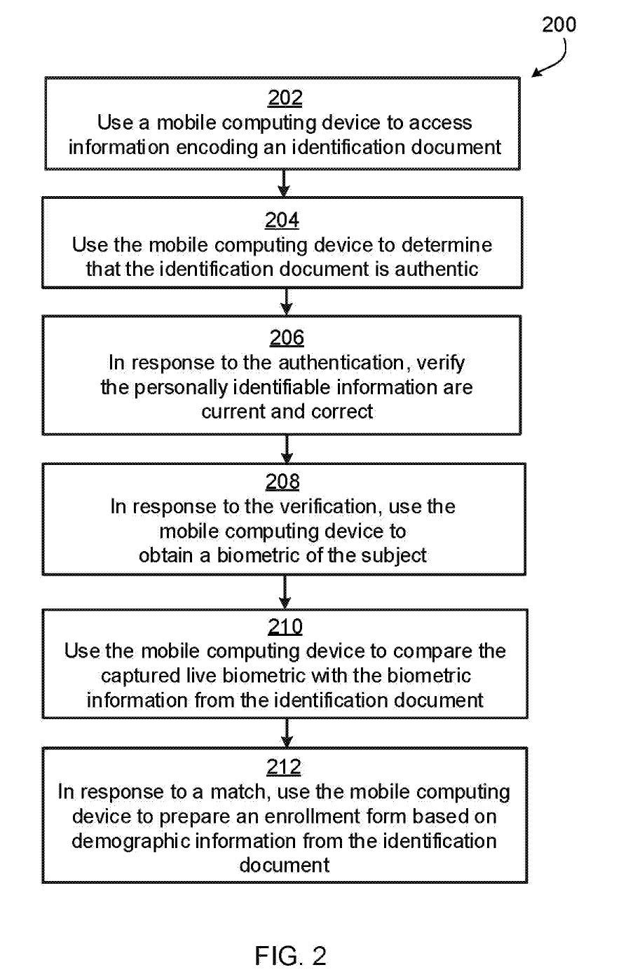

FIG. 2 shows an example of a process 200 for combining document authentication with biometric validation so that a subject can remotely assert an identity and enroll in a system. In some implementations, process 200 includes process steps relating to the workflow 100 of using a mobile application to perform subject enrollment by combining document authentication, subject verification, and information aggregation/synthesis.

Process 200 generally includes using a mobile computing device to access information encoding an identification document presented by a subject (202). The mobile computing device is used to determine that the identification document is authentic (204). In response to determining that the identification document is authentic, process 200 includes verifying that the personally identifiable information on the identification document are current and correct (206). For example, the mobile app of device 102 determines the authenticity of the identification document by analyzing information depicted in a high-resolution image of the identification document. In response to analyzing the information depicted in the image, the mobile app can detect or determine that one or more security features are embedded at the identification document. Based on the detected security features, the mobile app can correlate certain identifying data included at the document with data from secure database records that store identity information for various persons.

The mobile app can generate a confidence score that represents the results or outcome of the correlation. The mobile app can use the confidence score to determine that the identification document is a genuine or authentic identification document issued by a legitimate private or governmental issuing agency. In some implementations, the identification document includes biometric information for a subject. The biometric information can include a visual representation of a person's facial features, eye characteristics, blood type, fingerprint, or other related biometric features. In this implementation, determining that the identification document is a genuine or authentic identification document can also include determining that the biometric information included at the identification document is authentic.

The mobile app can employ a similar process to verify that personally identifiable information on the identification document is current and accurate. In some implementations, the mobile app uses a local or cloud based comparison engine to determine whether the personally identifiable information on the identity document matches current government issued identity records or other records of identity.

In response to determining that identifying information of the identification document is current and correct/accurate, the mobile computing device is used to obtain a biometric of the subject (208). For example, an optical scanning device (e.g., a digital camera) of the mobile computing device is used to obtain biometrics data representing one or more biometric features of the subject. Subsequently the mobile app of the computing device 102 can use the comparison engine to compare the obtained or captured biometric data with the biometric information from the identification document that has been authenticated (210). In some implementations, the obtained biometric is a live biometric represented by biometric data that is obtained in real-time. In response to determining a match between the biometric data and the biometric information from the identification document, the mobile app uses the mobile computing device to prepare one or more enrollment forms. For example, the enrollment forms can be prepared by incorporating the personally identifiable information from the identification document that has been authenticated (212).

The mobile computing device may first access information encoding an identification document (202). The information encoding an identification document may be obtained by scanning a physical copy of the identification document. The information may also be accessed by virtue of relying on a digital identification document. In some cases, the digital identification document may reside on the same mobile computing device.

The identification document may be authenticated by verifying the various security features (204). In some cases, the mobile computing device may confirm personally identifiable information (PII) from various regions on the identification document matches. Security features such as digital watermarks and/or guilloche patterns are present at various layers of the identification document. Information content from such security features correlate with otherwise printed information on the identification document.

In response to determining that the identification document is authentic, the mobile application may verify the personally identifiable information on the identification document are current and correct (206). For example, the mobile application can verify that the identification document is current by inspecting the expiration date of the identification document. If the expiration date is before the current date, the mobile application may determine that the identification document has expired. In other examples, the personally identifiable information from the identification document may be compared to a system of record, for example, administered by the Department of Motor Vehicles (DMV). The system of record may return a match or no-match answer. If the answer is a yes, then the personally identifiable information on the identification document has been verified as current and correct.

In response to verifying that identification document, the mobile application may then validate that the subject seeking enrollment is the person identified by the identification document (208). To this end, the mobile application may drive the mobile computing device to take a live biometric of the subject. The biometric may include, for example, a facial portrait, a gaiting pattern, a speech segment, a fingerprint, or a retina scan or the subject. The captured live biometric may be compared with the biometric information from the identification document. If the captured live biometric matches the biometric information from the identification document, the subject may be determined as the person identified by the identification document (210).

In response to the above three determinations, the mobile computing device may extract, for example, demographic information from the identification document and parse such information into an enrollment form for the subject to review, revise, and sign off (212). The forms may include employment verification form, benefit enrollment form, or tax-withholding form. By virtue of querying database information, the mobile computing device may determine a status of the subject for taking an employment, opening an account, or enrolling in a network.

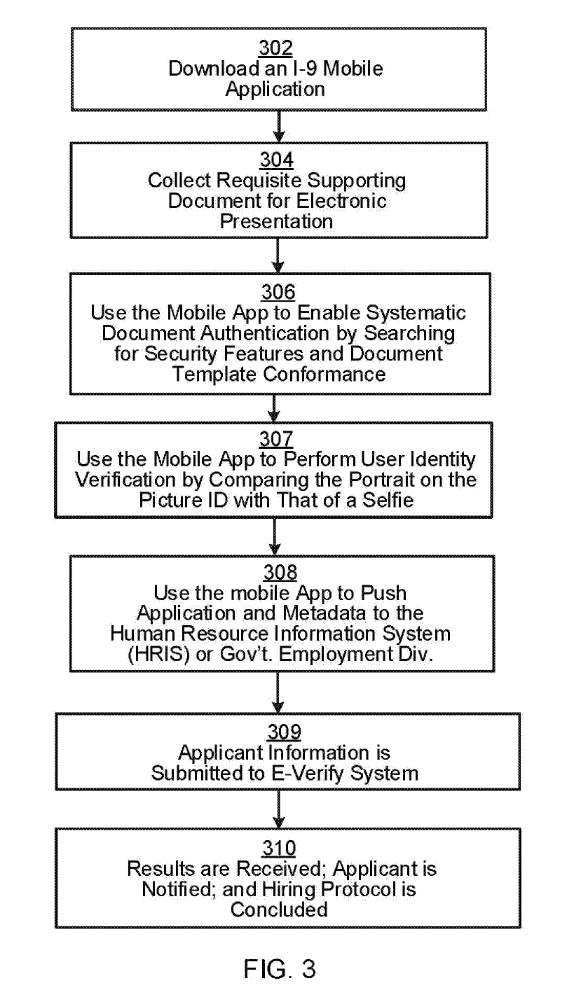

As illustrated in the example of FIG. 3, an applicant may download an I-9 mobile application to register for human resource benefits and regulatory compliance (302). The mobile application is configured and optimized for operation on a mobile device of the applicant, including, for example, iPhone devices and Android devices. In this example, the applicant may be a job candidate.

During this process, applicable form(s) for employment eligibility may be completed by the applicant through the mobile app on the mobile device; and supporting documents (including credentials and/or appropriate identity information (SSN, passport information, USCIS #) may be electronically presented to the mobile app on the mobile computing device. As illustrated, requisite supporting documents may be collected for electronic presentation (304). Examples of supporting documents include a driver's license, a passport, an employment authorization document (EAD), or a permanent resident card (e.g., a green card).

The applicant may use the mobile app to perform systematic document authentication by searching for security features and document template conformance (306). The applicant may also use the mobile app to perform user identity verification (307). In these instances, biometric data can be collected by using the applicant's mobile device. For example, selfies may be taken by the applicant's mobile device; finger prints may be captured by the applicant's mobile device. The captured biometric information may then be compared to information from the supporting documents of the applicant. The supporting documents may include, for example, one or more identification document as an identity credential. In one illustration, the portrait on the picture ID of the supporting documents is compared with that of, for example, a selfie taken from the mobile device of the applicant. In some instances, the document authentication and facial-recognition/comparison algorithms are locally resident on the mobile device of the applicant. Other instances may incorporate cloud-executed comparison algorithms.

The mobile app may then push application and metadata (i.e., comparison results, and images of scanned supporting documents if permitted by law) to the human resource information system (HRIS) (308). In some instances, this data operation is triggered automatically in response to the mobile app determining that the supporting documents are genuine and the captured biometric matches or substantially matches the information from the supporting documents. In some implementations, after pushing application data to the HRIS system, the mobile application is configured to obtain PII and other data that forms a set of worker information. The mobile application obtains this relevant worker information and sends the information to an example governmental organization or division that manages one or more employment and training databases. For example, the mobile application can send the information to a country or state's Department of Employment and Training database for processing to register a new worker or change in employer.

Thereafter, the applicant's information may be submitted to the E-Verify system (309). In some instances, the captured biometric information (e.g., captured live from the mobile device) and credential information (e.g., from the supporting documents) are compared to a remote database of data. In these instances, the E-Verify system may operate only on the back end by utilizing historical data from multiple sources. The manner in which the eligibility is tied to a vetted identity may be highly dependent on the up-front acquisition of the breeder documents. For example, when the quality of biometric capture and the assurance level of the supporting documents are higher than threshold levels, the E-Verify system may operate more deferentially. In other examples, the E-Verify system may take longer to compare the captured biometric information (e.g., in the submission) and credential information (e.g., from the supporting documents) to a multitude of remote databases of data.

In some instances, the remote databases may include databases administered or maintained by USCIS. The verification may follow USCIS protocols and schedules. While the applicant's information may be submitted to the E-Verify system, the HRIS may prepare the copied documents and application form for filing and internal compliance. This preparation process may be fully automated. In general, employer/representative are mandated to complete or review Applicant's submission and then verify employment information.

The verification results may be received after queries are answered; the applicant may be notified of the results and then the hiring protocols may conclude (310). Automations may be incorporated at this stage. In the above work flow, the human element can be generally removed. Through the use of APIs (or other programming standards), a fully automated paradigm is implemented in which multiple identity management systems operate in tandem to assist HR departments render a conditionally dependent employment eligibility decision.

The technical solution, as disclosed herein, closes the up-front identity gap, which used to be infeasible. These computer techniques implemented on mobile devices can improve workflow to capture previously unrealized potentials. In particular, the process turnaround time can be reduced to achieve t responsiveness where identity determination in the context of employment can be reliably made in an autonomous manner while improving data accuracy and consistency within the HRIS system.

As described throughout, computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer may include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the systems and techniques described here can be implemented on a computer having a display device (e.g., a CRT (cathode ray tube), LCD (liquid crystal display) monitor, LED (light-emitting diode) or OLED (organic light-emitting diode) monitors) for displaying information to the user and a keyboard and a pointing device (e.g., a mouse or a trackball) by which the user can provide input to the computer. Input devices might also be 3D. Other kinds of devices can be used to provide for interaction with a user as well; for example, feedback provided to the user can be any form of sensory feedback (e.g., visual feedback, auditory feedback, or haptic feedback including tactile feedback and kinesthetic feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention. For example, much of this document has been described with respect to messaging and mapping applications, but other forms of graphical applications may also be addressed, such as interactive program guides, web page navigation and zooming, and other such applications.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
accessing, at a mobile computing device, information encoding an identification document of a subject, the identification document comprising biometric information for the subject;
verifying that personally identifiable information (PII) including the biometric information on the identification document is valid;
in response to verifying that the PII is valid, obtaining, using the mobile computing device, a biometric of the subject;
determining, by the mobile computing device, that the subject is the person identified by the identification document based on the obtained biometric and the PII on the identification document; and
extracting, by the mobile computing device, at least a portion of the PII from the identification document to register the subject.

2. The method of claim 1, wherein verifying the PII comprises:
detecting a security feature of the identification document using the information encoding the identification document;
authenticating the identification document in response to determining that the detected security feature corresponds to security information in an identification database associated with a jurisdiction that issued the identification document; and
in response to authenticating the identification document, verifying that the PII on the identification document is valid.

3. The method of claim 2, wherein determining that the subject is the person identified by the identification document comprises:
comparing the obtained biometric with biometric information from the identification document that has been authenticated;
determining a match between the obtained biometric and at least a portion of the biometric information from the identification document; and
in response to determining the match, determining, by the mobile computing device, that the subject is the person identified by the identification document.

4. The method of claim 3, wherein the PII comprises demographic information and the method further comprises:
extracting the demographic information from the identification document;
accessing an enrollment template; and
loading the extracted demographic information into the enrollment template to register the subject.

5. The method of claim 4, wherein the method further comprises:
receiving, at the mobile computing device, an indication comprising employment data about the subject; and
loading the employment data into the enrollment template, wherein the employment data is loaded concurrent with the extracted demographic information to register the subject.

6. The method of claim 4, wherein the method further comprises:
obtaining, at the mobile computing device, an eligibility document configured to receive data about the subject; and
populating the eligibility document with one or more of:
the extracted demographic information;
the PII on the identification document that has been verified as valid; or
the biometric information from the identification document that has been authenticated.

7. The method of claim 6, wherein the method further comprises:
using at least the PII on the identification document that has been verified as valid to confirm an eligibility status of the subject.

8. The method of claim 7, wherein the eligibility document is an employment eligibility form and the method further comprises:
determining, using the mobile computing device, whether the subject is eligible for employment based on information from the authenticated identification document; and
receiving, at the mobile computing device, a verification result that indicates whether the subject is eligible for employment.

9. A system, comprising:
one or more processing devices; and
one or more non-transitory machine-readable storage devices storing instructions that are executable by the one or more processing devices to cause performance of operations comprising:
accessing, at a mobile computing device, information encoding an identification document of a subject, the identification document comprising biometric information for the subject;
verifying that personally identifiable information (PII) including the biometric information on the identification document is valid;
in response to verifying that the PII is valid, obtaining, using the mobile computing device, a biometric of the subject;
determining, by the mobile computing device, that the subject is the person identified by the identification document based on the obtained biometric and the PII on the identification document; and
extracting, by the mobile computing device, at least a portion of the PII from the identification document to register the subject.

10. The system of claim 9, wherein verifying the PII comprises:
detecting one or more security features of the identification document using the information encoding the identification document;
authenticating the identification document in response to determining that the detected one or more security features correspond to security information in an identification database associated with a jurisdiction that issued the identification document; and
in response to authenticating the identification document, verifying that the PII on the identification document is valid.

11. The system of claim 10, wherein determining that the subject is the person identified by the identification document comprises:
comparing the obtained biometric with biometric information from the identification document that has been authenticated;
determining a match between the obtained biometric and at least a portion of the biometric information from the identification document; and
in response to determining the match, determining, by the mobile computing device, that the subject is the person identified by the identification document.

12. The system of claim 11, wherein the PII comprises demographic information and the operations further comprise:
extracting the demographic information from the identification document;
accessing an enrollment template; and
loading the extracted demographic information into the enrollment template to register the subject.

13. The system of claim 12, wherein the operations further comprise:
receiving, at the mobile computing device, an indication comprising employment data about the subject; and
loading the employment data into the enrollment template, wherein the employment data is loaded concurrent with the extracted demographic information to register the subject.

14. The system of claim 12, wherein the operations further comprise:
obtaining, at the mobile computing device, an eligibility document configured to receive data about the subject; and
populating the eligibility document with one or more of:
the extracted demographic information;
the PII on the identification document that has been verified as valid; or
the biometric information from the identification document that has been authenticated.

15. The system of claim 14, wherein the operations further comprise:
using at least the PII on the identification document that has been verified as valid to confirm an eligibility status of the subject.

16. The system of claim 15, wherein the eligibility document is an employment eligibility form and the operations further comprise:
determining, using the mobile computing device, whether the subject is eligible for employment based on information from the authenticated identification document; and
receiving, at the mobile computing device, a verification result that indicates whether the subject is eligible for employment.

17. One or more non-transitory machine-readable storage devices storing instructions that are executable by one or more processing devices to cause performance of operations comprising:
accessing, at a mobile computing device, information encoding an identification document of a subject, the identification document comprising biometric information for the subject;
verifying that personally identifiable information (PII) including the biometric information on the identification document is valid;
in response to verifying that the PII is valid, obtaining, using the mobile computing device, a biometric of the subject;
determining, by the mobile computing device, that the subject is the person identified by the identification document based on the obtained biometric and the PII on the identification document; and
extracting, by the mobile computing device, at least a portion of the PII from the identification document to register the subject.

18. The one or more machine-readable storage devices of claim 17, wherein verifying the PII comprises:
detecting a security feature of the identification document using the information encoding the identification document;
authenticating the identification document in response to determining that the detected security feature corresponds to security information in an identification database associated with a jurisdiction that issued the identification document; and
in response to authenticating the identification document, verifying that the PII on the identification document is valid.

19. The one or more machine-readable storage devices of claim 18, wherein determining that the subject is the person identified by the identification document comprises:
comparing the obtained biometric with biometric information from the identification document that has been authenticated;
determining a match between the obtained biometric and at least a portion of the biometric information from the identification document; and
in response to determining the match, determining, by the mobile computing device, that the subject is the person identified by the identification document.

20. The one or more machine-readable storage devices of claim 19, wherein the PII comprises demographic information and the operations further comprise:
extracting the demographic information from the identification document;
accessing an enrollment template; and
loading the extracted demographic information into the enrollment template to register the subject.
